(19) United States
(12) Patent Application Publication
(10) Pub. No.: US 2026/0268238 A1
(43) Pub. Date: Sep. 10, 2026

(54) METHOD AND SYSTEM FOR GENERATING TRAVEL ITINERARY

(71) Applicants: Hyundai Motor Company, Seoul (KR); Kia Corporation, Seoul (KR)

(72) Inventor: Tae Heon KIM, Hwaseong-si (KR)

(73) Assignees: Hyundai Motor Company, Seoul (KR); Kia Corporation, Seoul (KR)

(21) Appl. No.: 19/316,328

(22) Filed: Sep. 2, 2025

(30) Foreign Application Priority Data
Mar. 10, 2025 (KR) 10-2025-0030690

(51) Int. Cl. G06Q 10/02; G06Q 30/0282; G06Q 30/0601; G06Q 50/14

(52) U.S. Cl. CPC G06Q 10/02; G06Q 30/0282; G06Q 30/06312; G06Q 50/14

(57) ABSTRACT

A method for generating a travel itinerary of a user, the method includes receiving basic itinerary data from a calendar database linked to a calendar of the user, analyzing the received basic itinerary data, receiving card transaction data of the user from a card company database, and extracting characteristics of the user from the card transaction data, receiving external travel data from a travel agency database, generating recommendation data by associating the extracted characteristics of the user with the external travel data, generating the travel itinerary of the user, using the analyzed basic itinerary data and the generated recommendation data and causing a user device or a vehicle to display the generated travel itinerary.

### CROSS-REFERENCE TO RELATED APPLICATION(S)

This application claims benefit of priority to Korean Patent Application No. 10-2025-0030690 filed on Mar. 10, 2025 in the Korean Intellectual Property Office, the disclosure of which is incorporated herein by reference in its entirety.

### BACKGROUND

### 1. Field

The present disclosure relates to a method and system for generating a travel itinerary. More specifically, the present disclosure relates to a method and system capable of providing a user with a personalized travel itinerary by analyzing a consumption history of a user.

### 2. Description of Related Art

With the advancement of promotional technologies through social network services (SNS), travelers have increasing opportunities to encounter promotional content related to various travel destinations and travel products across the country. However, despite such technological advances, it has been difficult for travelers to encounter personalized travel products tailored to each individual, except for receiving recommendations of points of interest (POIs) located along a route set between a departure point and a destination using a vehicle navigation system.

Accordingly, there is a need for a system and method capable of automatically recommending a personalized travel itinerary optimized for individual characteristics of a traveler, when establishing a travel plan.

### SUMMARY

An aspect of the present disclosure is to provide a method and system for generating a travel itinerary.

Another aspect of the present disclosure is to provide a method and system for generating a travel itinerary capable of automatically providing a user with a personalized travel itinerary without requiring the user to perform a separate search for establishing the travel itinerary.

However, the aspects of the present disclosure are not limited to those set forth herein, and other aspects set forth herein could be more easily understood by those skilled in the art from the description below.

According to an aspect of the present disclosure, there is provided a method for generating a travel itinerary of a user, the method including receiving basic itinerary data from a calendar database linked to a calendar of the user, analyzing the received basic itinerary data, receiving card transaction data of the user from a card company database, and extracting characteristics of the user from the card transaction data, receiving external travel data from a travel agency database, generating recommendation data by associating the extracted characteristics of the user with the external travel data, generating the travel itinerary of the user, using the analyzed basic itinerary data and the generated recommendation data and causing a user device or a vehicle to display the generated travel itinerary.

The analyzing the basic itinerary data may include performing text mining on the received basic itinerary data to extract and classify information on presence or absence of a travel schedule in the calendar of the user, a travel period, a travel region, and a travel companion from the received basic itinerary data.

The characteristics of the user may include personal information, family information, and a consumption status of the user. The personal information may include one or more of a gender and an age of the user. The family information may include one or more of a marital status and the number of family members of the user.

The extracting the characteristics of the user may include extracting, from the received card transaction data, one or more of a preferred consumption business category of the user, a preferred brand in the preferred consumption business category of the user, or a consumption amount history of the user for each preferred consumption business category, included in the card transaction data, by applying an artificial intelligence-based multi-classification model to extract the consumption status.

The external travel data may include location data of a travel product and travel product preferences of a plurality of other people excluding the user. The travel product preferences may include ratings by the other people for each consumption business category and ratings by the other people for each brand in a consumption business category. The consumption business category may include one or more of a restaurant, an experience place, and an accommodation place.

The recommendation data may include the location data of the travel product. The generating the recommendation data may include generating a candidate list in descending order of ratings for each consumption business category and ratings for each brand, from among consumption business categories overlapping between the preferred consumption business category of the user and consumption business categories of the other people, using the extracted consumption status.

The generating the travel itinerary of the user may include generating the travel itinerary in descending order of ratings from among travel products included in the generated candidate list, for which a distance between the location data of the travel product and a travel region of the user is less than a predetermined distance.

The method may further include receiving current location information of a vehicle of the user. The generating the travel itinerary of the user may further include generating, in further consideration of the current location information of the vehicle, the travel itinerary in descending order of ratings from among travel products included in the generated candidate list, for which a distance between the current location information of the vehicle and the location data of the travel product is less than the predetermined distance, when the distance between the location data of the travel product and the travel region of the user is greater than the predetermined distance.

The method may further include receiving information on a departure point and a destination of the user from a vehicle navigation of the user. The generating the travel itinerary of the user may further include generating the travel itinerary in descending order of ratings from among travel products included in the generated candidate list, for which a generated route between the departure point and the destination is the same as a location of the travel product.

The method may further include displaying the generated travel itinerary to the user.

According to another aspect of the present disclosure, there is provided a system for generating a travel itinerary of a user, the system including
a processor configured to: receive basic itinerary data from a calendar database linked to a calendar of the user, analyze the received basic itinerary data, receive card transaction data of the user from a card company database, and extract characteristics of the user from the card transaction data, receive external travel data from a travel agency database, generate recommendation data by associating the extracted characteristics of the user with the external travel data, generate the travel itinerary of the user, using the analyzed basic itinerary data and the generated recommendation data and cause a user device or a vehicle to display the generated travel itinerary.

In analyzing the basic itinerary data, the processor may be configured to perform text mining on the received basic itinerary data to extract and classify information on presence or absence of a travel schedule in the calendar of the user, a travel period, a travel region, and a travel companion from the received basic itinerary data.

The characteristics of the user may include personal information, family information, and a consumption status of the user. The personal information may include one or more of a gender and an age of the user. The family information may include one or more of a marital status and the number of family members of the user.

In extracting the characteristics of the user from the card payment data, the processor may be configured to extract, from the received card transaction data, one or more of a preferred consumption business category of the user, a preferred brand in the preferred consumption business category of the user, or a consumption amount history for each preferred consumption business category of the user, included in the card transaction data, by applying an artificial intelligence-based multi-classification model to extract the consumption status.

The external travel data may include location data of a travel product and travel product preferences of a plurality of other people excluding the user. The travel product preferences may include ratings by the other people for each consumption business category and ratings by the other people for each brand in a consumption business category. The consumption business category may include one or more of a restaurant, an experience place, and an accommodation place.

The recommendation data may include the location data of the travel product. In generating the recommendation data, the processor may be configured to generate a candidate list in descending order of ratings for each consumption business category and ratings for each brand, from among consumption business categories overlapping between the preferred consumption business category of the user and consumption business categories of the other people, using the extracted consumption status.

In generating the travel itinerary of the user, the processor may be configured to generate the travel itinerary in descending order of ratings from among travel products included in the generated candidate list, for which a distance between the location data of the travel product and a travel region of the user is less than a predetermined distance.

The processor may be configured to further receive current location information of a vehicle of the user. In generating the travel itinerary of the user, the processor may be configured to generate, in further consideration of the current location information of the vehicle, the travel itinerary in descending order of ratings from among travel products included in the generated candidate list, for which a distance between the current location information of the vehicle and the location data of the travel product is less than the predetermined distance, when the distance between the location data of the travel product and the travel region of the user is greater than the predetermined distance.

The processor may be configured to further receive information on a departure point and a destination of the user from a vehicle navigation of the user. In generating the travel itinerary of the user, the processor may be configured to generate the travel itinerary in descending order of ratings from among travel products included in the generated candidate list, for which a generated route between the departure point and the destination is the same as a location of the travel product.

The system may further include a data display unit (or a data display) configured to display the generated travel itinerary to the user.

According to another aspect of the present disclosure, there is provided software or a computer-readable medium having executable instructions for performing a travel itinerary generation method, and a computer program stored in the medium.

The features of the present disclosure briefly summarized above are merely exemplary aspects set forth in the following detailed description of the present disclosure, and are not intended to limit the scope of the present disclosure.

According to the present disclosure, a method and system for generating a travel itinerary may be provided.

In addition, according to the present disclosure, a method and system for generating a travel itinerary, capable of automatically providing a user with a personalized travel itinerary without requiring the user to perform a separate search for establishing the travel itinerary, may be provided.

The effects of the present disclosure are not limited to those set forth herein, and other effects not set forth herein could be clearly understood by those skilled in the art from the description below.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a flowchart illustrating a travel itinerary generation method, according to an example embodiment of the present disclosure;

FIG. 2 is a diagram illustrating a process in which a travel itinerary generation system receives data from a plurality of databases, according to an example embodiment of the present disclosure;

FIG. 3 is a diagram illustrating another example embodiment of a process in which a travel itinerary generation system receives data from a plurality of databases, according to an example embodiment of the present disclosure; and

FIG. 4 is a diagram illustrating a travel itinerary generation system according to an example embodiment of the present disclosure.

### DETAILED DESCRIPTION

Hereinafter, example embodiments of the present disclosure will be described clearly and specifically such that a person skilled in the art easily could carry out example embodiments using the drawings. However, the present disclosure may be implemented in various different forms and is not limited to the example embodiments described herein.

In describing the example embodiments of the present disclosure, when it is determined that a detailed description of a known configuration or function may unnecessarily obscure the gist of the present disclosure, the detailed description thereof will be omitted. In the drawings, components not related to the description of the present disclosure are omitted, and similar reference numerals are used for similar components.

In the present disclosure, when it is stated that one component is “connected to,” “coupled to,” or “linked to” another component, such expressions may include not only direct connections, but also indirect connections via other components therebetween. In addition, when a component is described as “comprising,” “including,” or “having” another component, unless specifically stated otherwise, the component may not exclude the presence of additional components, but rather may further include other components.

In the present disclosure, the terms such as first, second, A, B, (a), (b), and the like may be used to distinguish a component from another component, and may not imply any particular order and/or importance, or others in relation to the components, unless otherwise specified. Accordingly, a “first component” in one example embodiment may be referred to as a “second component” in another example embodiment, and vice versa.

In the present disclosure, mutually distinct components may be used to clearly describe respective characteristics, and such separation does not necessarily imply that the components are physically separated from each other. That is, a plurality of components may be integrated into a single hardware or software unit, or a single component may be distributed across a plurality of hardware or software units. Accordingly, integrated or distributed example embodiments, even if not explicitly stated, are also included within the scope of the present disclosure.

In the present disclosure, components described in various example embodiments do not necessarily indicate essential components, and some components may be optional components. Accordingly, an example embodiment including a subset of the components described in one example embodiment may also be included within the scope of the present disclosure. In addition, an example embodiment including additional components in addition to the components described in various example embodiments is also included within the scope of the present disclosure.

With the advancement of navigation technologies, when a vehicle driver searches for a route using a navigation of a terminal or an in-vehicle infotainment system, a function may be provided that recommends various waypoints located along the route. However, such waypoint recommendation functions may merely consider a distance between the route and the waypoints or a current location of a vehicle, and may not consider personalized information such as a consumption tendency of a user.

According to a method and system for generating a travel itinerary according to an example embodiment of the present disclosure, when a user inputs a rough travel itinerary using an itinerary recording function (for example, a calendar application) of a user terminal (device) or a vehicle, a personalized travel itinerary may be provided to the user in consideration of basic itinerary information such as a region and a period of the itinerary, as well as an existing card transaction history of the user and rating information for respective travel products provided by a travel product company.

Hereinafter, a method and system for generating a travel itinerary according to an example embodiment of the present disclosure will be described with reference to the accompanying drawings.

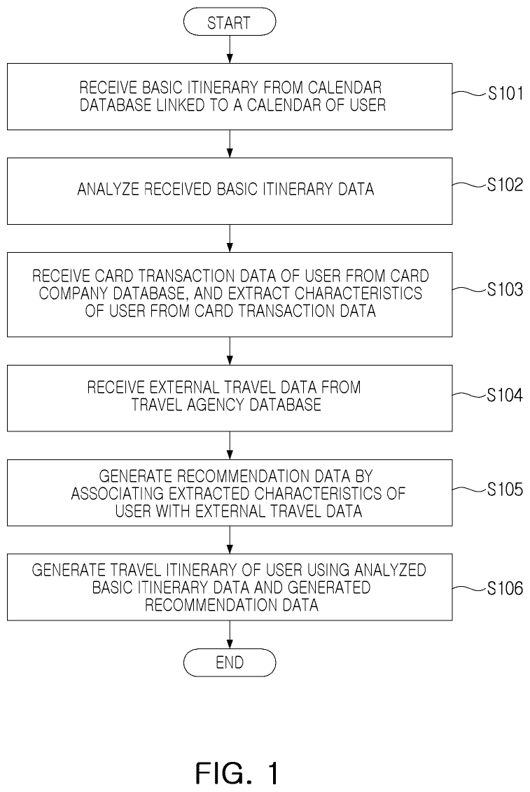

FIG. 1 is a flowchart illustrating a travel itinerary generation method, according to an example embodiment of the present disclosure.

Respective operations of the travel itinerary generation method, illustrated in FIG. 1, may be performed by a travel itinerary generation system to be described below.

Referring to FIG. 1, basic itinerary data may be received from a calendar database linked to a calendar of a user (S101). The reception in operation S101 may be performed by the travel itinerary generation system.

A user may input a travel schedule into a calendar implemented in the form of an application, using a user terminal (for example, a smartphone) or an in-vehicle function. When the user inputs the travel schedule into the calendar, the input itinerary information may be stored in a database located internally or externally relative to the user terminal. In the present disclosure, the database in which the calendar information of the user is input may be referred to as a “calendar database.” The calendar database may be implemented in various forms and is not limited to a specific implementation.

According to an example embodiment of the present disclosure, the basic itinerary data input by the user may be received from the calendar database. The basic itinerary data may refer to the basic information input into the calendar by the user. That is, any type of itinerary information, generally input into the calendar via the smartphone or the like, may correspond to the basic itinerary data.

According to the travel itinerary generation method of an example embodiment of the present disclosure, the basic itinerary data, received in operation S101, may be analyzed (S102).

Operation S102 may be an operation of performing text mining on the basic itinerary data received in operation S101 to extract and classify meaningful information from among various pieces of information included in the basic itinerary data.

For example, artificial intelligence-based text mining may be performed on the basic itinerary data input by the user to extract presence or absence of an itinerary in the calendar, a travel period including dates, departure and/or expected arrival times, information on a travel companion, a destination, an estimated consumption amount, and a purpose of the itinerary (for example, business trip or leisure travel). However, the present disclosure is not limited thereto, and any type of information, related to travel input into the calendar by the user, may be extracted.

According to an example embodiment, a classification may be performed on the itinerary input into the calendar to determine whether the itinerary relates to a business trip or leisure travel. Specifically, the classification of the itinerary may be performed first, and additional itinerary-related information may be extracted only for an itinerary classified as a travel-related itinerary.

The text mining may refer to a general artificial intelligence-based text analysis technique, in which unstructured data is preprocessed and converted into a structured format, followed by a series of operations including information extraction, pattern analysis, and evaluation.

According to the travel itinerary generation method according to an example embodiment of the present disclosure, card transaction data of the user may be received from a card company database, and characteristics of the user may be extracted from the card transaction data (S103).

The card company database may refer to a database including a card transaction history regardless of a type of card, such as a credit card or a debit card possessed by the user. Accordingly, when the user possesses cards issued by a plurality of card companies, a plurality of card company databases may be present. An existing card transaction history included in a card company database may include various types of information such as a transaction time, a transaction method, a transaction amount, a transaction location, and whether reward points were used. Accordingly, according to an example embodiment, an operation of extracting the characteristics of the user from the card transaction history may be performed to identify a consumption tendency of the user. In general, in the case of a restaurant, the card transaction history may include a name of the restaurant (for example, Seoul Galbi House). In the case of an experience activity, the card transaction history may include items from which a type of experience is inferable (for example, Daegwallyeong Sheep Ranch).

The characteristics of the user according to an example embodiment may include personal information, family information, and a consumption status of the user.

The personal information of the user may include a gender, an age, and an age group of the user.

The family information of the user may include a marital status and the number of family members of the user.

The consumption status of the user may include a preferred consumption business category of the user, a preferred brand in the preferred consumption business category of the user, and a consumption amount history in the corresponding business category and/or brand.

According to an example embodiment of the present disclosure, an artificial intelligence-based multi-classification model may be applied to the card transaction data of the user to extract the above-described personal information, family information, and/or a consumption status. However, the present disclosure is not limited thereto, and various AI-based extraction techniques may be used to extract, from the card transaction data of the user, meaningful user characteristics, including the personal information, the family information, and the consumption status.

For example, when card payment data of the user received from the card company database includes a consumption history in which the user used a corresponding card during a recent one-year period, the artificial intelligence-based multi-classification model according to an example embodiment may be applied, such that types of restaurants at which the user made purchases during the corresponding period (for example, Korean, Chinese, Japanese restaurants) may be extracted. In addition, an average consumption amount for each type of restaurant may be calculated. In addition, when a preferred brand of the user exists for each type of restaurant, brand information may also be extracted together therewith.

As another example, the artificial intelligence-based multi-classification model according to an example embodiment may be applied, such that types of experiential learning consumed by the user during the corresponding period (for example, an escape room cafe, a zoo visit, or the like) may be extracted. In addition, an average consumption amount for each type of experiential learning may be calculated. Similarly, when a preferred brand of the user exists for each type of experiential learning, brand information may also be extracted together.

According to an example embodiment, not only an average consumption amount for each business category but also a total consumption amount may be extracted together.

In addition, according to the travel itinerary generation method according to an example embodiment of the present disclosure, external travel data may be received from a travel agency database (S104).

According to an example embodiment of the present disclosure, reception of the card payment data from the card company database and reception of the external travel data from the travel agency database according to operation S104 may be performed simultaneously or in a reverse order.

The travel agency database may be a database including information on preferences of clients for travel products maintained by travel product companies. That is, the travel agency database according to an example embodiment of the present disclosure may be a database maintained by a plurality of travel agencies, and thus a plurality of databases. In this case, the corresponding database may include travel ratings of a plurality of other people, including or excluding the user. That is, the external travel data, included in the travel agency database, may include preferences of users for a travel product and location data on the travel product. In addition, in association with the corresponding travel ratings, a location of the corresponding travel product may be stored together. The travel product may refer to a place in which consumption may occur regardless of type, such as a restaurant, a cafe, an experience place, a park, a hotel, or the like.

Travel product-related data, stored in the travel agency database, may include information on preferences of users for the corresponding travel product, and the preferences may include a rating for each business category included in the travel product and a rating for each brand in the corresponding business category.

For example, the business category associated with the travel product-related data, stored in the travel agency database, may include a restaurant, a cafe, an experience place (for example, a zoo, a botanical garden, or the like), a performance place, a lodging place, and the like, but the present disclosure is not limited thereto.

In addition, the travel agency database may store not only the above-described preferences for each travel product but also various types of additional information such as a time zone during which users are concentrated for the corresponding travel product, website information related to the travel product, favorable weather, temperature and humidity for using the travel product, a main user age group and a gender, a satisfaction level by age group and gender, available hours of the travel product, seasons, and the like. A travel itinerary generation system according to an example embodiment may receive all the above-described travel product information from the travel agency database.

In addition, according to the travel itinerary generation method according to an example embodiment of the present disclosure, recommendation data may be generated by associating the extracted characteristics of the user with the external travel data (S105).

The recommendation data may be data generated based on card payment data of the user and external travel data and may be data for recommending a travel product optimized for a consumption tendency and personal information of the user.

The recommendation data may include location data of the travel product included in the external travel data.

The recommendation data may refer to data most suitable for the characteristics of the user, among pieces of the external travel data received from the travel agency database, based on the characteristics of the user extracted from the card payment data of the user.

For example, when a plurality of preferred consumption business categories, included in the consumption status of the user, correspond to a business category (and a brand) included in the external travel data received from the travel agency database, all data related to the corresponding business type (and brand) may be included in the recommendation data. For example, as an example of data included in the recommendation data, a recommendation candidate list may be generated in descending order of preferences (ratings) of users, included in the external travel data, for each business category and/or brand.

As another example, not only the consumption status of the user, but also the personal information or family information of the user may be used. That is, based on information such as a gender, an age group, and a marital status of the user, extracted from the card payment data of the user, pieces of information corresponding to the information of the user may be extracted from among pieces of travel product information included in the external travel data, and recommendation data may be generated. For example, as described above, travel product locations, consumption business categories, and brands preferred by users having the same or substantially overlapping a gender, an age group, a marital status, and the number of family members as the user may be arranged in descending order of ratings and included in the recommendation data in the form of a candidate list.

Alternatively, even when the characteristics of the user and the business categories included in the external travel data do not overlap, a list may be generated in descending order of user ratings, from among travel products included in the external travel data, which are located within a predetermined distance from places among a plurality of places included in the card payment data of the user, and recommendation data may be generated.

The above-described candidate list may include information on one or more of a location of a travel product, a usage price of the travel product, genders, ages, occupations, and the number of family members of main users, an average duration of stay, availability of discounts, start and end times, and peak usage hours, but the present disclosure is not limited thereto.

In addition, according to the travel itinerary generation method according to an example embodiment of the present disclosure, the travel itinerary of the user may be generated using the analyzed basic itinerary data and the generated recommendation data (S106).

Operation S106 of generating the travel itinerary of the user may be a process of ultimately providing the user with an optimal travel itinerary based on the consumption history of the user, by associating the recommendation data generated in operation S105 with the basic itinerary data received from the calendar database of the user.

The basic itinerary data may include information on a period and a region of travel input by the user using a calendar application or the like. According to an example embodiment of the present disclosure, the travel itinerary of the user may be generated based on the information the travel region included in the basic itinerary data and location data of a travel product included in the recommendation data.

In an example embodiment, the travel itinerary may be generated in descending order of ratings, from among travel products included in the recommendation data generated in the form of a recommendation candidate list in operation S105, for which a distance between the location data of the travel product and the travel region information input into the calendar by the user is less than a predetermined distance. For example, the predetermined distance may be set by the user directly or by an administrator of the travel itinerary generation system.

However, in some cases, the user may travel to a region different from the travel region input into the calendar. Thus, the travel itinerary generation system according to an example embodiment may further receive current location information of a terminal used by the user and/or a vehicle boarded by the user. That is, in preparation for a case in which a current location of the user is different from a location of a planned travel destination, the travel itinerary may be generated in descending order of ratings from among travel products included in the generated candidate list, for which a distance between the current location information of the terminal and/or vehicle of the user and location data of the travel product is less than a predetermined distance. In other words, the travel itinerary generation system according to an example embodiment may generate, in further consideration of the current location information of the terminal or vehicle of the user, the travel itinerary in descending order of ratings from among travel products included in the candidate list generated in operation S105, for which a distance between the current location information of the terminal or vehicle and the location data of the travel product is less than the predetermined distance, even when a distance between the location data of the travel product and the travel region of the user is greater than the predetermined distance.

In another example embodiment, when the user sets a departure point and a destination using a navigation included in the terminal (for example, a smartphone) or an infotainment system of the vehicle, the travel itinerary of the user may be generated, based on a route according to the navigation, using travel products for which each travel point on the route is the same as, or within a predetermined distance from a location of a travel product.

In another example embodiment, the travel itinerary generation system according to an example embodiment may receive information on weather at a current location or destination, and a real-time traffic volume on a route. The travel itinerary of the user may be generated in descending order of ratings from among travel products included in the recommendation data generated in the form of a candidate list in operation S105, for which a distance from a current location to the travel product exhibits a lowest traffic volume. Alternatively, the travel itinerary generation system according to an example embodiment may receive information on a current weather of a destination stored in the calendar of the user, and the travel itinerary of the user may be generated using a travel product most suitable for the current weather among travel products included in the external travel data, which are located within a predetermined distance from the destination.

As described above, it has been described that the candidate list is generated in descending order of ratings, but the present disclosure is not limited thereto, and the recommendation data may be generated in the form of a candidate list based on various criteria, such as in ascending order of price ranges, or in ascending order of average number of users.

Operation S106 of generating the travel itinerary of the user may be provided in the form of a candidate list, and may be provided to the user in the form of voice and/or text. The means for providing the itinerary is not limited to a specific example embodiment such as a terminal or a vehicle of the user.

For example, the travel itinerary of the user generated in operation S106 may be displayed to the user through a screen of a smartphone of the user. Alternatively, the travel itinerary may be displayed to the user through a screen of a vehicle of the user.

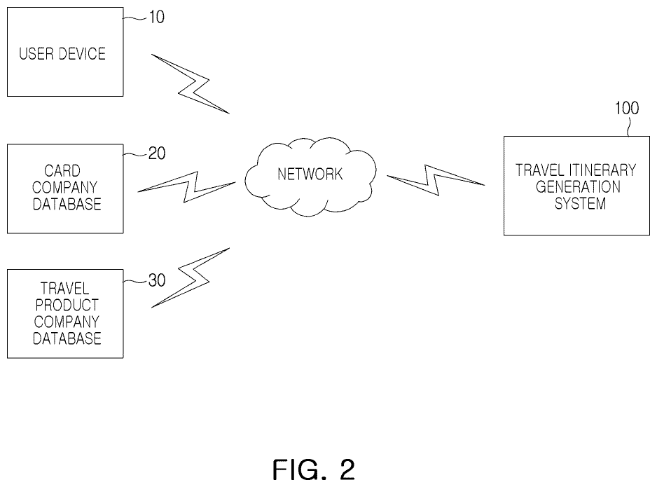

FIG. 2 is a diagram illustrating a process in which a travel itinerary generation system receives data from a plurality of databases, according to an example embodiment of the present disclosure.

Referring to FIG. 2, a form is illustrated in which a travel itinerary generation system 100, performing the travel itinerary generation method described with reference to FIG. 1, receives data from various databases located externally.

The travel itinerary generation system 100 according to an example embodiment may receive pieces of data required for generating a travel itinerary of a user from a user device 10 or a user vehicle, a card company database 20, and a travel product company database 30 via a network, in order to perform respective operations in the above-described travel itinerary generation method. For example, a network environment illustrated in FIG. 2 may include both wired and wireless network environments.

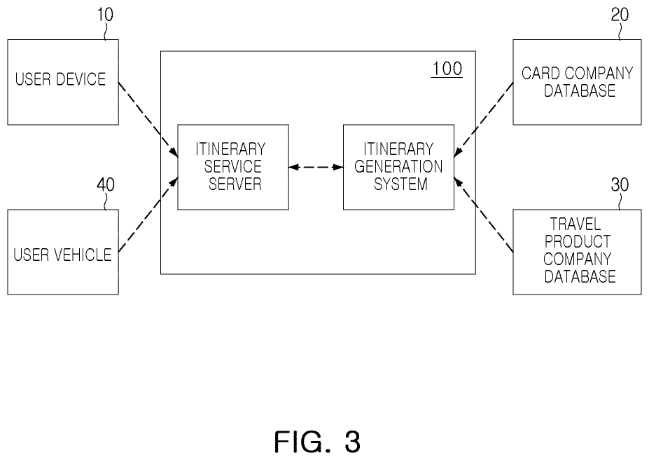

FIG. 3 is a diagram illustrating another example embodiment of a process in which a travel itinerary generation system receives data from a plurality of databases, according to an example embodiment of the present disclosure.

Referring to FIG. 3, a travel itinerary generation system 100 according to an example embodiment may include an itinerary service server and an itinerary generation system therein. However, the present disclosure is not limited thereto.

The itinerary service server illustrated in FIG. 3 may receive information collected in relatively real time from a user device 10 and/or a user vehicle 40. The itinerary service server may receive basic itinerary data of a user in real time from a user calendar application. In addition, information on a vehicle current location, a vehicle navigation, or weather may be received from the user vehicle 40.

The itinerary generation system illustrated in FIG. 3 may perform a function of receiving data respectively from a card company database 20 and a travel product company database 30, and generating recommendation data by associating, in advance, the received data.

The descriptions of FIGS. 2 and 3 are an example embodiment for performing the travel itinerary generation method described with reference to FIG. 1, and the descriptions of FIG. 1 may also be equally applied to FIGS. 2 and 3.

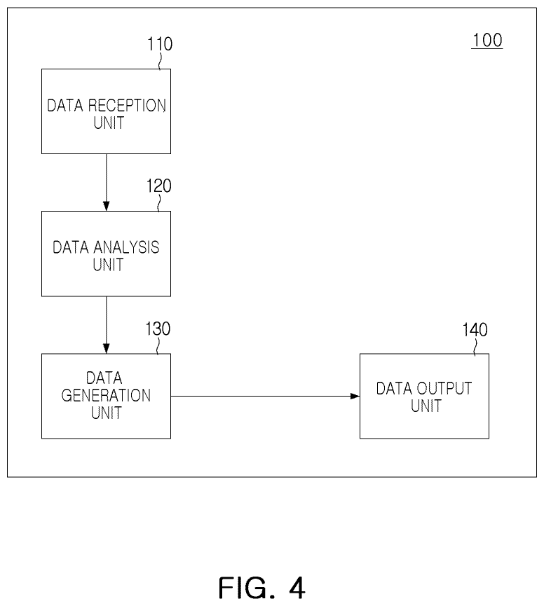

FIG. 4 is a diagram illustrating a travel itinerary generation system according to an example embodiment of the present disclosure.

A travel itinerary generation system 100 illustrated in FIG. 4 may be the same as the travel itinerary generation system described with reference to FIGS. 1 to 3, and the above descriptions may be equally applied to FIG. 4.

The travel itinerary generation system 100 according to an example embodiment of the present disclosure may be implemented to be located in a smartphone, vehicle, or the like of a user, or may be implemented and located externally, separately therefrom.

Referring to FIG. 4, the travel itinerary generation system 100 according to an example embodiment may include a data reception unit 110, a data analysis unit 120, a data generation unit 130, and a data output unit 140, but the present disclosure is not limited thereto, and may further include unillustrated components necessary to generate and provide a travel itinerary to a user. Alternatively, the travel itinerary generation system 100 may not include the data output unit 140 in some cases. According to an exemplary embodiment of the present disclosure, the travel itinerary generation system 100 may be implemented by a hardware device including various electronic circuits (e.g., computer, microprocessor, CPU, ASIC, circuitry, logic circuits, etc.) In some embodiments, the travel itinerary generation system 100 may include a processor and an associated non-transitory memory storing software instructions which, when executed by the processor, provides the functionalities of the data reception unit 110, the data analysis unit 120, the data generation unit 130, and the data output unit 140. Herein, the memory and the processor may be implemented as separate semiconductor circuits. Alternatively, the memory and the processor may be implemented as a single integrated semiconductor circuit. The processor may embody one or more processor(s).

The data reception unit 110 may receive basic itinerary data from a calendar database linked to a calendar of the user.

In addition, the data reception unit 110 may receive card payment data of the user from a card company database 20 and receive external travel data from a travel agency database 30.

In addition, the data reception unit 110 may further receive information on a current location of a terminal 10 or a vehicle 40 of the user, and information on a departure point and a destination from a navigation in the vehicle 40 of the user.

The data analysis unit 120 may analyze the received basic itinerary data. In addition, the data analysis unit 120 may extract characteristics of the user from the card payment data.

For example, the characteristics of the user may include personal information, family information, and a consumption status of the user. The personal information may include one or more of a gender and an age of the user. In addition, the family information may include one or more of a marital status and the number of family members of the user.

In analyzing the basic itinerary data, the data analysis unit 120 may perform text mining on the received basic itinerary data to extract and classify information on presence or absence of a travel schedule in the calendar of the user, a travel period, a travel region, and a travel companion from the received basic itinerary data.

In addition, in extracting the characteristics of the user from the card payment data, the data analysis unit 120 may extract, from the received card transaction data, one or more of a preferred consumption business category of the user, a preferred brand in the preferred consumption business category of the user, or a consumption amount history for each preferred consumption business category of the user, included in the card transaction data, by applying an artificial intelligence-based multi-classification model to extract the consumption status.

For example, the external travel data may include location data of a travel product and travel product preferences of a plurality of other people excluding the user, the travel product preferences may include ratings by the other people for each consumption business category and ratings by the other people for each brand in a consumption business category, and the consumption business category may include one or more of a restaurant, an experience place, and an accommodation place.

The data generation unit 130 may generate recommendation data by associating the extracted characteristics of the user with the external travel data. In addition, the data generation unit 130 may generate the travel itinerary of the user using the analyzed basic itinerary data and the generated recommendation data. For example, the recommendation data may include the location data of the travel product.

In generating the recommendation data, the data generation unit 130 may generate a candidate list in descending order of ratings for each consumption business category and ratings for each brand, from among consumption business categories overlapping between the preferred consumption business category of the user and consumption business categories of the other people, using the extracted consumption status.

In addition, in generating the travel itinerary of the user, the data generation unit 130 may generate, in further consideration of current location information of the vehicle, the travel itinerary in descending order of ratings from among travel products included in the generated candidate list, for which a distance between the current location information of the vehicle and the location data of the travel product is less than a predetermined distance, when a distance between the location data of the travel product and the travel region of the user is greater than the predetermined distance.

In addition, in generating the travel itinerary of the user, the data generation unit 130 may generate the travel itinerary in descending order of ratings from among travel products included in the generated candidate list, for which a generated route between the departure point and the destination is the same as a location of the travel product.

The data output unit 140 according to an example embodiment may display the generated travel itinerary to the user. Alternatively, the data output unit 140 may provide the generated travel itinerary of the user to the user device 10 or the user vehicle 40.

Exemplary methods of the present disclosure are described as a series of operations for clarity of description; however, the order of operations is not intended to be limiting. Respective operations may be performed simultaneously or in a different order, if necessary. In order to implement the method according to the present disclosure, additional operations may be included in addition to exemplary operations, some operations may be excluded, or some operations may be excluded and other additional operations may be included.

Various example embodiments of the present disclosure are not intended to list all possible combinations, but are intended to describe representative aspects of the present disclosure. The features described in the various example embodiments may be applied independently or in combination of two or more.

In addition, the various example embodiments of the present disclosure may be implemented in hardware, firmware, software, or a combination thereof. In the case of hardware implementation, the example embodiments may be implemented using one or more application-specific integrated circuits (ASICs), digital signal processors (DSPs), digital signal processing devices (DSPDs), programmable logic devices (PLDs), field-programmable gate arrays (FPGAs), general processors, controllers, microcontrollers, or microprocessors.

The scope of the present disclosure includes software or machine-executable instructions (for example, operating systems, applications, firmware, programs) that cause operations according to methods of the various example embodiments to be executed on a device or computer, and non-transitory computer-readable media in which the software or instructions are stored and which are executable on a device or computer.

While example embodiments have been shown and described above, it will be apparent to those skilled in the art that modifications and variations could be made without departing from the scope of the present disclosure as defined by the appended claims.

What is claimed is:

1. A method for generating a travel itinerary of a user, the method comprising:
receiving basic itinerary data from a calendar database linked to a calendar of the user;
analyzing the received basic itinerary data;
receiving card transaction data of the user from a card company database, and extracting characteristics of the user from the card transaction data;
receiving external travel data from a travel agency database;
generating recommendation data by associating the extracted characteristics of the user with the external travel data;
generating the travel itinerary of the user, using the analyzed basic itinerary data and the generated recommendation data; and
causing a user device or a vehicle to display the generated travel itinerary.

2. The method of claim 1, wherein the analyzing the basic itinerary data includes:
performing text mining on the received basic itinerary data to extract and classify information on presence or absence of a travel schedule in the calendar of the user, a travel period, a travel region, and a travel companion from the received basic itinerary data.

3. The method of claim 1, wherein
the characteristics of the user include personal information, family information, and a consumption status of the user,
the personal information includes one or more of a gender and an age of the user, and
the family information includes one or more of a marital status and the number of family members of the user.

4. The method of claim 3, wherein the extracting the characteristics of the user includes extracting, from the received card transaction data, one or more of a preferred consumption business category of the user, a preferred brand in the preferred consumption business category of the user, or a consumption amount history of the user for each preferred consumption business category, included in the card transaction data, by applying an artificial intelligence-based multi-classification model to extract the consumption status.

5. The method of claim 4, wherein
the external travel data includes location data of a travel product and travel product preferences of a plurality of other people excluding the user,
the travel product preferences include ratings by the other people for each consumption business category and ratings by the other people for each brand in a consumption business category, and
the consumption business category includes one or more of a restaurant, an experience place, and an accommodation place.

6. The method of claim 5, wherein
the recommendation data includes the location data of the travel product, and
the generating the recommendation data includes generating a candidate list in descending order of ratings for each consumption business category and ratings for each brand, from among consumption business categories overlapping between the preferred consumption business category of the user and consumption business categories of the other people, using the extracted consumption status.

7. The method of claim 6, wherein the generating the travel itinerary of the user includes generating the travel itinerary in descending order of ratings from among travel products included in the generated candidate list, for which a distance between the location data of the travel product and a travel region of the user is less than a predetermined distance.

8. The method of claim 7, further comprising:
receiving current location information of a vehicle of the user,
wherein the generating the travel itinerary of the user further includes generating, in further consideration of the current location information of the vehicle, the travel itinerary in descending order of ratings from among travel products included in the generated candidate list, for which a distance between the current location information of the vehicle and the location data of the travel product is less than the predetermined distance, based on that the distance between the location data of the travel product and the travel region of the user is greater than the predetermined distance.

9. The method of claim 8, further comprising:
receiving information on a departure point and a destination of the user from a vehicle navigation of the user,
wherein the generating the travel itinerary of the user further includes generating the travel itinerary in descending order of ratings from among travel products included in the generated candidate list, for which a generated route between the departure point and the destination is the same as a location of the travel product.

10. The method of claim 4, wherein the consumption status includes an average consumption amount information associated with a user.

11. A system for generating a travel itinerary of a user, the system comprising:
a processor configured to:
receive basic itinerary data from a calendar database linked to a calendar of the user;
analyze the received basic itinerary data;
receive card transaction data of the user from a card company database, and extracting characteristics of the user from the card transaction data;
receive external travel data from a travel agency database;
generate recommendation data by associating the extracted characteristics of the user with the external travel data;
generate the travel itinerary of the user, using the analyzed basic itinerary data and the generated recommendation data; and
cause a user device or a vehicle to display the generated travel itinerary.

12. The system of claim 11, wherein in analyzing the basic itinerary data, the processor is configured to perform text mining on the received basic itinerary data to extract and classify information on presence or absence of a travel schedule in the calendar of the user, a travel period, a travel region, and a travel companion from the received basic itinerary data.

13. The system of claim 11, wherein
the characteristics of the user include personal information, family information, and a consumption status of the user,
the personal information includes one or more of a gender and an age of the user, and
the family information includes one or more of a marital status and the number of family members of the user.

14. The system of claim 13, wherein in extracting the characteristics of the user from the card payment data, the processor is configured to extract, from the received card transaction data, one or more of a preferred consumption business category of the user, a preferred brand in the preferred consumption business category of the user, or a consumption amount history for each preferred consumption business category of the user, included in the card transaction data, by applying an artificial intelligence-based multi-classification model to extract the consumption status.

15. The system of claim 14, wherein
the external travel data includes location data of a travel product and travel product preferences of a plurality of other people excluding the user,
the travel product preferences include ratings by the other people for each consumption business category and ratings by the other people for each brand in a consumption business category, and
the consumption business category includes one or more of a restaurant, an experience place, and an accommodation place.

16. The system of claim 15, wherein
the recommendation data includes the location data of the travel product, and
in generating the recommendation data, the processor is configured to generate a candidate list in descending order of ratings for each consumption business category and ratings for each brand, from among consumption business categories overlapping between the preferred consumption business category of the user and consumption business categories of the other people, using the extracted consumption status.

17. The system of claim 16, wherein in generating the travel itinerary of the user, the processor is configured to generate the travel itinerary in descending order of ratings from among travel products included in the generated candidate list, for which a distance between the location data of the travel product and a travel region of the user is less than a predetermined distance.

18. The system of claim 17, wherein
the processor is configured to further receive current location information of a vehicle of the user, and
in generating the travel itinerary of the user, the processor is configured to generate, in further consideration of the current location information of the vehicle, the travel itinerary in descending order of ratings from among travel products included in the generated candidate list, for which a distance between the current location information of the vehicle and the location data of the travel product is less than the predetermined distance, based on that the distance between the location data of the travel product and the travel region of the user is greater than the predetermined distance.

19. The system of claim 18, wherein
the processor is configured to further receive information on a departure point and a destination of the user from a vehicle navigation of the user, and
in generating the travel itinerary of the user, the processor is configured to generate the travel itinerary in descending order of ratings from among travel products included in the generated candidate list, for which a generated route between the departure point and the destination is the same as a location of the travel product.

20. The system of claim 14,
wherein the consumption status includes an average consumption amount information associated with a user.
